(19) United States
(12) Patent Application Publication
(10) Pub. No.: US 2026/0312691 A1
(43) Pub. Date: Oct. 8, 2026

(54) Multi-Band Software-Defined Radio System for Detecting Surroundings, as Well as Methods and Motor Vehicle

(71) Applicant: Volkswagen Aktiengesellschaft, Wolfsburg (DE)

(72) Inventors: Heiko Gustav Kurz, Hannover (DE); Tobias SCHWABE, Paderborn (DE); Marc-Michael MEINECKE, Sassenburg (DE); Stephan KRUSE, Paderborn (DE); Christoph SCHEYTT, Dorsten (DE)

(73) Assignee: Volkswagen Aktiengesellschaft, Wolfsburg (DE)

(21) Appl. No.: 19/483,483

(22) PCT Filed: Apr. 25, 2024
(86) PCT No.: PCT/EP2024/061418

§ 371 Date: Nov. 11, 2025

(30) Foreign Application Priority Data
May 11, 2023 (DE) 10 2023 204 352.1

(51) Int. Cl. H04B 10/516; G01S 7/35; G01S 13/931

(52) U.S. Cl. CPC H04B 10/516; G01S 7/35; G01S 13/931

(57) ABSTRACT

The disclosure relates to a software-defined radio system for detecting surroundings, comprising an optical apparatus for generating an optical carrier signal, a transmission apparatus, which is designed to emit electrical emission signals which are based on the optical carrier signal, and an electro-optical modulator, which has a predetermined operating point. The electro-optical modulator is designed to generate multiple optical output signals on the basis the predetermined operating point and the optical carrier signal in such a way that the multiple optical output signals have different frequency bands from one another. The electro-optical modulator apparatus is configured to generate multiple optical emission signals on the basis of the multiple optical output signals by modulating the multiple optical output signals with at least one electrical CW signal.

### CROSS-REFERENCE TO RELATED APPLICATIONS

This application claims priority to German Patent Application DE 10 2023 204 352.1, filed on May 11, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a software-defined radio system for detecting surroundings. The software-defined radio system has an optical apparatus for generating an optical carrier signal. The software-defined radio system also has a transmission apparatus which is designed to emit electrical emission signals based on the optical carrier signal.

The disclosure further relates to a method for operating a software-defined radio system.

The disclosure also relates to a motor vehicle having a software-defined radio system.

### SUMMARY

A need exists to provide an improved software-defined radio system with reduced complexity.

The need is addressed by the subject matter of the independent claim(s). Embodiments of the invention are described in the dependent claims, the following description, and the drawings.

### BRIEF DESCRIPTION OF THE DRAWINGS

FIG. 1 is a schematic representation of an example motor vehicle which has an example software-defined radio system;

FIG. 2 is a schematic representation of an example computing apparatus and a transmission apparatus of the software-defined radio system from FIG. 1; and

FIG. 3 is a schematic representation of an example receiving apparatus of the software-defined radio system from FIG. 1.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments relate to a software-defined radio system for detecting surroundings, comprising
an optical apparatus for generating an optical carrier signal,
a transmission apparatus which is designed to emit electrical emission signals which are based on the optical carrier signal, having:
an electro-optical modulator which has a predetermined operating point,
the electro-optical modulator, which is designed to generate multiple optical output signals on the basis of the predetermined operating point and the optical carrier signal in such a way that the multiple optical output signals have different frequency bands from one another,
an electro-optical modulator apparatus which is designed to generate multiple optical emission signals on the basis of the multiple optical output signals by modulating the multiple optical output signals with at least one electrical CW signal, and
the transmission apparatus, which is designed to convert the multiple optical emission signals into multiple electrical emission signals and to emit the multiple electrical emission signals with at least one radio-based transmission unit.

The proposed software-defined radio system can be used to create a radar system that is less complex and still has multiple frequency bands by means of one, in particular single, electro-optical modulator.

In contrast to today's optically supported radar systems, the proposed software-defined radio system uses multiple frequency bands or else radar frequency bands to detect objects. Thanks to the electro-optical modulator of the software-defined radio system according to the teachings herein, there is no need for a separate phase shifter to generate the bands, in contrast to known multi-band optically assisted radar systems. Such radar or else frequency bands were previously separated using an optical filter and the radar ramp was modulated in a separate electro-optical modulator. This can be improved by the proposed software-defined radio system.

In particular, the proposed software-defined radio system requires only one electro-optical modulator for the generation of radar signals in different frequency bands or else bands. For example, the software-defined radio system may be a radar system. For example, the software-defined radio system can be used as a photonic multi-band radar system.

The term “software-defined radio—SDR” covers concepts for high-frequency transmitters and high-frequency receivers in which smaller or larger portions of the signal processing are realized with software.

The proposed software-defined radio system can perform much of the signal processing with a computing apparatus, such as a universal computer or, if required, a combination with dedicated hardware, such as signal processors and/or FPGAs.

In particular, the proposed software-defined radio system can be used to provide a software-defined radio system or else a radio system in which different modulation parameters, different bandwidths, temporal behavior and different channel coding methods can be implemented simply by changing the software.

The software-defined radio system can be used as a software-defined radio system for detecting surroundings or as a system for data transmission. For example, the software-defined radio system can have analog-to-digital converters, digital-to-analog converters and the software-based digital signal processing in between.

In particular, the electro-optical modulator and/or the electro-optical modulator apparatus can be at least partially software-based or completely software-based. For this purpose, for example, corresponding implementations can take place on a computing apparatus of the software-defined radio system.

First, the electro-optical modulator can generate the multiple optical output signals, which have different frequency bands, on the basis of the optical carrier signal and the predetermined or else specific operating point. These can then be provided or else transmitted in turn to the electro-optical modulator apparatus so that the multiple optical output signals can be modulated there with at least one electrical CW signal or with a separate CW signal in each case. A CW signal is a “continuous wave” signal or else an uninterrupted wave. The CW signal is an undamped, i.e., temporally constant, radiated wave. In particular, the CW signal may be a narrow-band signal.

The generation of the multiple optical output signals and the modulation of the multiple optical emission signals can be at least partially software-based.

For example, a sinusoidal signal can be used as a CW signal for the modulation.

In contrast to the software-defined radio systems in the prior art, the proposed software-defined radio system does not use separate hardware components for each individual generation of a frequency band. With the help of the proposed software-defined radio system, different frequency bands can be generated with the same component or else unit using the electro-optical modulator.

Furthermore, the proposed software-defined radio system makes it possible to actuate multiple bands or else frequency bands with special hardware, in particular a single piece of hardware, such as the electro-optical modulator. This minimizes the costs and complexity of the overall system, in particular the software-defined radio system, for detecting the surroundings. A further benefit of the software-defined radio system is, for example, that the software-defined radio system can dispense with a mode-locked laser (MLL) and separately actuated phase shifters for the generation of different frequency bands. This also eliminates the need for optical bandpass filters, which separate the bands from each other before each individual frequency band is then actuated separately. This can be dispensed with by the proposed software-defined radio system.

Since the electro-optical modulator of the software-defined radio system can be used to generate or else actuate multiple frequency bands or else radar bands by means of a unit or else a hardware component, the complexity, the probability of failure and the costs of the software-defined radio system according to the teachings herein can be reduced compared to software-defined radio systems in the prior art.

By dispensing with a phase shifter, which is not possible in the prior art, costs and complexity can be reduced. By dispensing with a mode-locked laser (MLL), which is used in known systems to generate the frequency bands, the software-defined radio system according to the teachings herein has further benefits.

Due to their design, MLLs have only a short service life and are very expensive. As a result, the probability of failure of the system having the MLL increases and the system cannot be implemented cost-effectively. For the separation of the frequency bands, additional optical bandpass filters are required, which are discretely very expensive and generate additional energy, such as additional heat dissipation, which in turn must be compensated for. This increases the power loss of the system or else the costs of the system. These mentioned issues of using an MLL can be addressed with the proposed software-defined radio system.

In contrast to the prior art, the proposed software-defined radio system only requires one electro-optical modulator to generate multiple frequency bands or else radar bands. Furthermore, through optical clock distribution, the software-defined radio system can also be used for large-scale equipment systems.

By slightly modifying the hardware, the software-defined radio system can be used as a radar system. By selecting the required components of the software-defined radio system, the software-defined radio system can be realized as a discrete, integrated or partially integrated solution.

In contrast to the service life problems of a mode-locked laser, the electro-optical modulator has a longer service life, which in turn has a positive effect on the software-defined radio system.

In particular, the electro-optical modulator is designed in such a way that it can generate multiple optical signals which have different frequency bands from each other. For this purpose, the electro-optical modulator can be operated at a predetermined or else special operating point. For example, the electro-optical modulator can be driven or else operated as an operating point at a point at which many, at least some, harmonics of possible identical amplitudes can be generated. In particular, the electro-optical modulator can be operated especially at an operating point at which at least two harmonic signals can be generated. A harmonic can be understood as a harmonic oscillation, the frequency of which is an integer multiple of a base frequency. The base frequency can be predetermined by the optical carrier signal.

In particular, the Nyquist can be used as the operating point. Accordingly, the electro-optical modulator can have an operating mode which can be or else is defined on the basis of the Nyquist point. A Nyquist point or else critical point is a point up to which a system is stable, taking into account the Nyquist criterion. Furthermore, taking into account the Nyquist-Shannon sampling theorem, all portions in a signal can have frequencies lower than the Nyquist frequency so that the sampled signal can be reconstructed with any accuracy. This is beneficial for the present software-defined radio system, since the corresponding radar or else sensor information can be evaluated or else reconstructed accordingly for the detection of objects, in particular for the detection of the surroundings.

With the help of the electro-optical modulator, three frequency bands or else the corresponding signals can be used, for example, simultaneously to detect the surroundings. This is particularly beneficial for improved location classification.

The multiple optical emission signals can be generated coherently to each other, as a result of which these phases are identical. This means that the multiple emission signals generated are coupled to each other in a phase-synchronized manner.

The proposed software-defined radio system can be used in a wide variety of application areas, such as aerospace, shipping, agriculture, the automotive industry or in automotive systems.

In particular, the software-defined radio system can be used in motor vehicles that can move at least partially autonomously, but in particular also those that are operated fully autonomously. In order to make such automated travel possible, reliable perception of the surroundings is essential. Here, the surroundings or else environment is detected by means of sensors, for example radar. Comprehensive 360-degree three-dimensional detection of the environment is particularly important, such that all static and dynamic objects can be detected. The software-defined radio system can be used for this purpose. For example, the software-defined radio system can be designed as a photonic radar system by co-integrating the electronic and photonic components into one, in particular single, semiconductor chip. The tracking of a FMCW signal as well as the overall signal processing and signal evaluation can be carried out in a central station or else central computing apparatus. For example, the optical apparatus can be used to transmit a gigahertz signal as an optical carrier signal, in particular in the terahertz frequency range. A central station, which can also be referred to as a central electronic computing apparatus, generates an optical carrier frequency, in particular the optical carrier signal. In particular, all data, in particular for detecting the surroundings, can be processed on the central station.

Specifically, spectral properties of the optical emission signals can be the same as the electrical emission signals.

For example, the optical apparatus or else an optical laser can generate a 77 gigahertz FMCW signal as a carrier signal.

For example, at least the optical apparatus can be provided to modulate the optical transmission signal or else the optical carrier signal directly and/or by means of external components.

Specifically, the electro-optical modulator can be referred to as an electro-optical converter unit or else electro-optical converter apparatus.

In some embodiments, it is provided that the electro-optical modulator apparatus is designed to modulate each of the multiple optical output signals with the at least one electrical CW signal. Consequently, depending on the area of use or else application of the software-defined radio system, the optical emission signals provided for emission can be generated by modulating the multiple optical output signals. In the process, each of the multiple optical output signals can either be modulated with one and the same CW signal. It is also conceivable that a separate or else individual electrical CW signal for the modulation can be provided and used for each of the multiple optical output signals.

In some embodiments, it is provided that the electro-optical modulator apparatus has multiple electro-optical modulators, wherein the multiple electro-optical modulators are designed to modulate each of the multiple optical output signals with a different electrical CW signal. The electro-optical modulator apparatus can have multiple or else a plurality of electro-optical modulators. The number of electro-optical modulators can be established by the number of output signals and depending on how many different frequency bands are required, in particular for detecting the surroundings. This means that a separate electro-optical modulator can be used individually for each output signal and thus for each frequency band to modulate the respective optical output signal or else the respective frequency band.

For example, the multiple electro-optical modulators can be operated at the same or else an identical operating point as the electro-optical modulator. It is also conceivable that the multiple electro-optical modulators are operated at different operating points.

In some embodiments, it is provided that the multiple electro-optical modulators of the electro-optical modulator apparatus are connected in series or parallel to each other. Depending on the application or else area of use of the software-defined radio system, parallel modulation or serial modulation can be used to generate the optical emission signals.

In some embodiments, it is provided that the transmission apparatus has at least one optical-electronic converter unit, with which the multiple optical emission signals can be converted into the multiple electrical emission signals. For example, the multiple optical emission signals can be transmitted to the transmission apparatus via optical transmission paths or else optical transmission links. For example, this can be done via fiber-optic connections. The transmitted multiple optical emission signals can then be converted by means of one or more optical-electronic converter units or else optical-electrical converter apparatuses such that the multiple electrical emission signals can be provided or else made available to the at least one radio-based transmission unit, such as a radar sensor, for emission.

In addition or instead, the transmission apparatus may have at least one frequency manipulator, with which at least one frequency band of one of the multiple electrical emission signals can be changed. For example, the transmission apparatus may have multiple frequency manipulators or else mixers. With the aid of the at least one frequency manipulator, a frequency band of one of the multiple emission signals or multiple frequency bands of the multiple electrical emission signals can be converted into a higher or lower frequency band on the basis of a defined bandwidth. This means that frequency conversion can be carried out using the frequency manipulator. In other words, the frequency manipulator can be used to manipulate at least one frequency band of one of the multiple electrical emission signals for emission, in particular for detecting the surroundings.

In addition or instead, the transmission apparatus has at least one electrical amplifier for amplifying at least one frequency band of one of the multiple electrical emission signals. In addition to the at least one electrical amplifier, the transmission apparatus can have further electrical amplifiers. In particular, an amplifier can be provided for each of the multiple electrical emission signals so that a frequency band of each electrical emission signal can be electrically amplified for emission.

The radio-based transmission unit can be an apparatus that can detect the surroundings by means of radio-based, electrical and/or electromagnetic signals. The radio-based transmission unit can therefore be a radar unit, for example.

The multiple optical emission signals generated can be provided or else transmitted via optical transmission paths of the radio-based transmission unit as well as of the optical transmission unit, so that the various signals, which have different frequency bands, are emitted indirectly as electrical signals by means of conversion and/or manipulation. This means that a software-defined radio system that can be used as a radar system can be provided.

In some embodiments, it is further provided that the software-defined radio system has a receiving apparatus which has at least one radio-based receiving unit for receiving at least one electrical reception signal. In addition, the receiving apparatus can have at least one mixer or else frequency manipulator, with which a frequency band of the at least one electrical reception signal can be changed. Furthermore, the software-defined radio system has a computing apparatus which is designed to process the electrical reception signal.

Electrical signals, such as the at least one electrical reception signal, can be received with the aid of the radio-based receiving unit.

For example, the at least one electrical reception signal may be a signal corresponding to the multiple electrical emission signals. In particular, the electrical emission signals are emitted into the environment and when they hit an object, a reflected signal can be reflected back. This can be the electrical reception signal, for example. In particular, the electrical reception signal contains information about the surroundings, in particular radar information. For example, for every emitted electrical emission signal, a corresponding electrical reception signal reflected in the environment can be received by the transmission apparatus.

The at least one received electrical reception signal or the multiple received electrical reception signals can be processed accordingly and its frequency band can be changed, in particular upconverted or downconverted, using, for example, the at least one mixer or else a frequency manipulator.

In particular, the computing apparatus may be a central computing apparatus. The computing apparatus can be connected or else coupled, for example, to the transmission apparatus and/or receiving apparatus so as to transmit signals or else data. The receiving apparatus can have corresponding outputs and inputs so that, for example, the received electrical reception signals can be transmitted to the computing apparatus so that the respective signals can be evaluated or else processed. The surroundings can thus be detected.

For example, the central processing or else processing of data, signals and information, in particular with regard to detecting the surroundings, takes place in the central computing apparatus.

In particular, the computing apparatus and the components of the computing apparatus can be designed to be at least partially software-based. Accordingly, parts of the signal generation, signal processing and signal evaluation can be carried out using software or else software implementations.

For example, the computing apparatus can be used to control the transmission apparatus and/or the receiving apparatus. In particular, the computing apparatus can be used as an actuation and evaluation unit of the software-defined radio system and, in particular, for the transmission apparatus and for the receiving apparatus.

Accordingly, a wide range of transmission apparatuses and/or receiving apparatuses, for example, can be controlled or else operated or else actuated with one and the same central computing apparatus.

The computing apparatus can be coupled to the transmission apparatus and/or receiving apparatus via one or more optical fibers and/or electrical lines.

In some embodiments, it is provided that the computing apparatus has the electro-optical modulator and/or the electro-optical modulator apparatus. Thus, the computing apparatus can be used as the central unit for generating the multiple optical output signals and the multiple optical e signals. This means that the optical emission signals can be pre-processed in the computing apparatus and then transmitted to the transmission apparatus to be emitted via an optical transmission path.

Some embodiments relate to a method for operating a software-defined radio system according to the teachings herein. The electro-optical modulator is operated in a specific operating mode, wherein in the specific operating mode of the electro-optical modulator, the multiple optical output signals are generated such that the multiple optical output signals have different frequency bands from each other, and the multiple optical output signals are modulated with the at least one electrical CW signal by the electro-optical modulator apparatus so that the multiple optical emission signals are generated.

In particular, the method just described can be used to operate a software-defined radio system as described above. Here, the electro-optical modulator can be operated at an operating point at which as many harmonics of possible identical amplitudes as possible can be generated. This allows different frequency bands to be generated with an electro-optical modulator. This means that the software-defined radio system can be used more extensively, in particular for better detection of the environment.

In some embodiments, it is provided that the electro-optical modulator is operated in the specific operating mode in such a way that the Nyquist point is defined as the operating point of the electro-optical modulator. As a result, multiple harmonic signals can consequently be generated. In particular, the Nyquist point offers the benefit that the multiple optical emission signals are in phase with each other. This allows stable signals to be generated and emitted to detect the surroundings.

Some embodiments relate to a motor vehicle having a software-defined radio system according to the teachings herein. In particular, the motor vehicle just described contains a software-defined radio system according to the teachings herein.

In particular, the motor vehicle is an assisted or at least partially autonomously operated vehicle. In particular, the motor vehicle is a highly automated motor vehicle that contains various driver assistance systems. Said driver assistance systems can access the proposed software-defined radio system and call up information about the surroundings, for example. In particular, the motor vehicle may have multiple such software-defined radio systems.

By using “software-defined radio technology,” a sensor system for detecting surroundings can be designed or else created that is more compact and can be designed with fewer hardware components. This means that such a sensor system requires less space for installation, making it particularly beneficial for use in automated systems, in particular in highly automated vehicles.

In particular, multiple transmission apparatuses and multiple receiving apparatuses may be arranged in and/or on the motor vehicle. These apparatuses, in turn, can be coupled to the central computing apparatus, which is integrated centrally in the motor vehicle, for example.

The motor vehicle is for example designed as an automobile, in particular as a passenger car or truck or as a passenger bus or motorcycle. Moreover, trams, subway trains, railway trains, ships, airplanes, satellites, and other mobile units may also be equipped with this (sensor) technology.

For example, the units of the software-defined radio system may be arranged so as to be distributed on the motor vehicle, in particular for detecting surroundings. In particular, the software-defined radio system may be a surroundings detection system.

Such a software-defined radio system can, in particular, be used in motor vehicles, rail-bound vehicles, watercraft or in automated systems or in aeronautical engineering or in aerospace engineering. In particular, the software-defined radio system can be used for surroundings detection or else for detecting objects or environmental pollution.

In the embodiments described herein, the described components of the embodiments each represent individual features that are to be considered independent of one another, in the combination as shown or described, and in combinations other than shown or described. In addition, the described embodiments can also be supplemented by features other than those described.

A surroundings sensor system may, for example, be understood as a software-defined radio system that is capable of generating sensor data or sensor signals that depict, represent, or reproduce the environment of the surroundings sensor system. In particular, the ability to detect electromagnetic or other signals from the environment is not sufficient for a software-defined radio system to be considered a surroundings sensor system. For example, cameras, radar systems and/or ultrasonic sensor systems can be regarded as software-defined radio systems.

The disclosure also includes embodiments of the motor vehicle according to the teachings herein and of the method according to the teachings herein that have features which have already been described in conjunction with the embodiments of the software-defined radio system. For this reason, the corresponding embodiments of the motor vehicle and of the method will not be described again.

The teachings herein also include combinations of the features of the described embodiments.

In the following, the invention is presented in greater detail with reference to the FIGS. It should be noted that different aspects are described which may be used alone or in combination. In other words, any aspect can be used with different embodiments unless explicitly presented as a pure alternative. Specific references to components, process steps, and other elements are not intended to be limiting. Further, it is understood that like parts bear the same or similar reference numerals when referring to alternate FIGS.

Furthermore, in the following, reference is generally only made to one entity for the sake of simplicity. Unless explicitly stated, however, the teachings herein may also comprise more than one of the entities concerned. In this regard, the use of the word “a” and “one” should be understood as an indication that at least one entity is used in a simple embodiment.

Where methods are described in the following, the individual steps of a method can be arranged and/or combined in any desired order, unless the context explicitly indicates otherwise. Furthermore, the methods can be combined with one another unless expressly indicated otherwise.

As a general rule, numerical information should not be understood as exact values, but rather also include a tolerance of from +/−1% to +/−10%.

References to standards or specifications should be understood as references to standards or else specifications that apply/applied at the time H the application and/or—if priority is claimed—at the time of the priority application. However, this does not imply a general exclusion of applicability to subsequent or replacement standards or specifications.

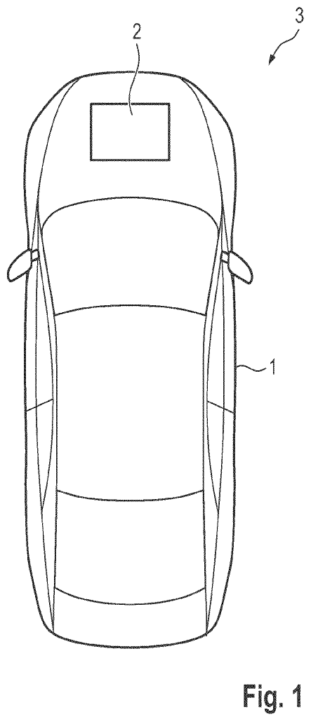

FIG. 1 is a schematic plan view of an embodiment of a motor vehicle 1. The motor vehicle can be designed, for example, as a highly automated vehicle or as an at least partially autonomously operated vehicle.

The motor vehicle 1 can, for example, have a software-defined radio system 2. The software-defined radio system 2 can be used for surroundings detection of an environment 3 of the motor vehicle 1. For example, the software-defined radio system 2 may be a component of a driver assistance system of the motor vehicle 1. In particular, the software-defined radio system 2 supplies corresponding information, in particular relating to the environment 3, to the driver assistance system or a vehicle guidance system.

In addition to the use of the software-defined radio system 2 in the motor vehicle 1, said software-defined radio system can also be used in vehicle-external systems. For example, the software-defined radio system 2 can be applied in automated systems, in aerospace engineering, in aeronautical engineering, or in communication technology.

Again, the example in which the software-defined radio system 2 is integrated into the motor vehicle 1 is shown in FIG. 1 for illustrative purposes.

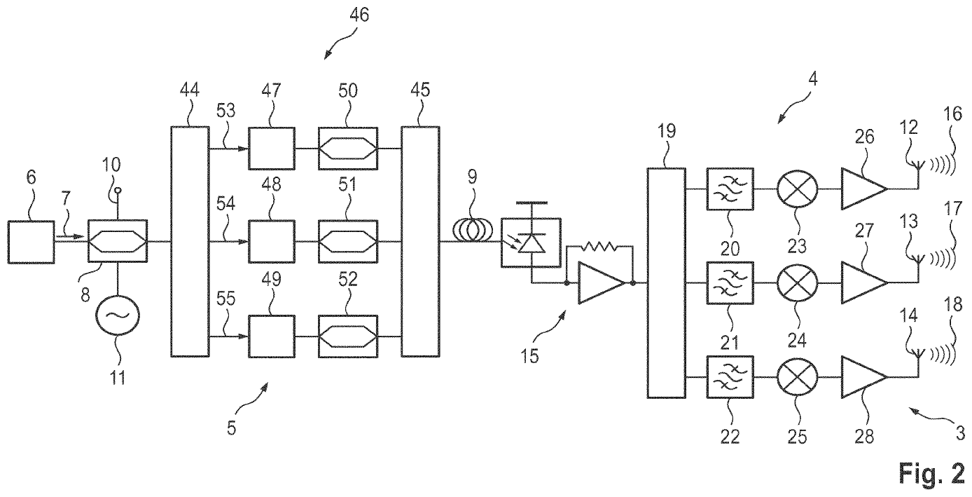

FIG. 2 shows an example of one of multiple embodiments 44 the software-defined radio system 2 in a representation, in particular in a block diagram.

FIG. 2 shows an example of a transmission apparatus 4 and a computing apparatus 5 of the software-defined radio system 2. The computing apparatus 5 serves, in particular, for the signal processing and/or signal evaluation for the software-defined radio system 2.

The computing apparatus 5 may, for example, be a central unit or else a central control unit or else a central actuation unit of the software-defined radio system 2.

In particular, the software-defined radio system 2 has an optical apparatus 6, with which an optical carrier signal 7 or else an optical transmission signal can be provided or else generated. The optical apparatus 6 can be integrated into the computing apparatus 5, as shown as an example in FIG. 2.

The optical apparatus 6 can be, for example, a laser apparatus or else an optical source.

In FIG. 2 shown, the optical apparatus 6 is integrated in the computing apparatus 5. However, this is just one possible example. Equally, the optical apparatus 6 may be designed as a standalone unit.

The software-defined radio system 2 can have an electro-optical modulator 8, which is integrated into or else arranged in the computing apparatus 5, for example. The electro-optical modulator 8 can be used to generate multiple optical emission signals 9 (shown here in simplified form) on the basis of the optical carrier signal 7. In particular, the electro-optical modulator 8 is designed in such a way that radar ramps or else radar signals or else emission signals can be realized in different bands or else frequency bands. Accordingly, the software-defined radio system only requires a single electro-optical modulator 8 for this purpose. To realize this, the electro-optical modulator 8 is operated at a predetermined or else specific operating point. Here, an operating point is driven or else actuated by generating as many harmonics as possible, i.e., harmonic oscillations, the frequency of which is an integer multiple of a base frequency. The base frequency can in turn be provided by means of the optical carrier signal 7. These harmonics can have an identical amplitude. In order to realize this, the Nyquist point can be used as the operating point 10.

On the basis of the operating point 10 and the optical carrier signal 7, the multiple optical emission signals 9 can be generated in such a way that the multiple optical emission signals 9 have different frequency bands from one another. For this purpose, the electro-optical modulator 8 can optionally be additionally modulated with a CW signal 11. This may be, above all, a sinusoidal signal.

To detect the surroundings, the software-defined radio system 2 has at least one transmission apparatus 4, which has at least one radio-based transmission unit 12. In this exemplary embodiment, three or else multiple radio-based transmission units 12, 13, 14 are shown. The radio-based transmission unit 12, 13, 14 can be a unit or else apparatus based on a radar sensor.

The multiple optical emission signals 9 generated can be transmitted or else sent to the transmission apparatus 4 or other transmission apparatuses of the software-defined radio system 2, for example, via optical transmission paths, such as optical fibers.

The transmission apparatus 4 can have, for example, at least one optical-electronic converter unit 15. This converter unit 15 is used for opto-electronic conversion of the multiple optical emission signals 9 into multiple electrical emission signals 16, 17, 18. After conversion, the electrical emission signals 16, 17, 18 can be separated accordingly by means of a splitter 19, in particular according to their frequency band. The distributor 19 can be, for example, a “1×3 power divider.” Furthermore, a narrow-band opto-electronic converter or an electrical bandpass filter can be used as a distributor 19. In the connection to the distributor 19, the electrical emission signals 16, 17, 18 can be separated or else divided according to their frequency bands 20, 21, 22. For example, the electrical emission signals 16, 17, 18 and also the multiple optical emission signals 9 can be coherent with each other and, in particular, in phase with each other. Accordingly, the proposed software-defined radio system 2 can be operated or else used in such a way that measurements are taken simultaneously or else synchronously on multiple different frequency bands, as shown in FIG. 2 on three different frequency bands. This is particularly beneficial for location classification with regard to surroundings detection.

After the electrical emission signals 16, 17, 18 have been separated, their respective frequency bands 20, 21, 22 can be changed, in particular upconverted, using a frequency manipulator 23, 24, 25 or else a frequency mixer. Furthermore, the respective frequency bands 20, 21, 22 can then be amplified by means of respective electrical amplifiers 26, 27, 28. After the electrical emission signals 16, 17, 18 have been upconverted and amplified, they can be emitted or else radiated into the environment 3 by means of respective radio-based transmission units 16, 17, 18, which can be referred to, for example, as antennas, in order to detect the surroundings.

For example, the transmission apparatus 4 can be referred to as a transmission module. The transmission apparatus 4 can be controlled or else operated, for example, with the aid of the computing apparatus 5 so that at least one radar-based signal, i.e. the signals 16, 17, 18, can be emitted. In particular, the embodiment in FIG. 2 shows the use of the software-defined radio system 2 as a radar system. The electro-optical modulator 8 according to the teachings herein can be used to create a multi-band radar. In particular, this can be referred to as “Nyquist pulse multi-band radar.”

The computing apparatus 5 can be a spatially and/or physically separate unit from the transmission apparatus 4. In this case, the computing apparatus 5 and the transmission apparatus 4 can be connected via multiple optical transmission paths or else optical transmission links in order to exchange or else transmit the optical signals. In a further embodiment, it is also possible that the transmission apparatus 4 and the computing unit 5 are integrated into a common unit.

FIG. 2 shows, for example, that the different frequency bands 20, 21, 22 of the emission signals can be emitted with a transmission apparatus 4. It is also conceivable that a separate transmission apparatus 4 is used for each emission signal or else for each frequency band.

In particular, the software-defined radio system 2 can be designed or else configured accordingly depending £ on the application.

After the electro-optical modulator 8, the multiple optical output signals 53, 54, 55 can be split accordingly with a unit 44, such as a “1×3 power split.” Here, the multiple output signals 53, 54, 55 can be split according to the respective frequency bands. Optical filters 47, 48, 49 can also be used for this purpose. After splitting or else filtering, the output signals 53, 54, 55 can be provided or else transmitted to a corresponding electro-optical modulator 50, 51, 52. With the aid of the optical modulators 50, 51, 52, each of the multiple optical output signals 53, 54, 55 can be modulated with the at least one electrical CW signal 11 or a different electrical CW signal in each case. This allows the optical emission signals 16, 17, 18 to be generated. These can in turn be combined with a unit 45, such as a “1×3 power combiner.” In this way, the multiple optical emission signals 9 can be transmitted to the transmission apparatus 4, for example by means of optical fibers or other optical transmission paths.

For example, the units 44, 45, 47, 48, 49, 50, 51 and 52 can be components or else units of an electro-optical modulator apparatus 46. The electro-optical modulator apparatus 46 can be used to generate the multiple optical emission signals 9 on the basis of the multiple optical output signals 53, 54, 55 by modulating the multiple optical output signals 53, 54, 55 with at least one or more sinusoidal signals or else the CW signal 11.

For example, each electro-optical modulator 50, 51, 52 can be operated with an individual operating point. It is also conceivable that the electro-optical modulator 8 and the electro-optical modulators 50, 51, 52 have the same operating point 10.

For the realization of the software-defined radio system 2 as a sensor system for detecting surroundings, at least some of the components can be software-based.

In the event that the same signal, i.e. the CW signal 11, is to be modulated on all optical harmonics, i.e. the frequency bands of the output signals 53, 54, 55, the output signals of the first electro-optical modulator, i.e. the electro-optical modulator 8, can be fed into a second electro-optical modulator, i.e. the electro-optical modulator apparatus 46, so that all harmonics are then modulated by means of the CW signal. In the event that different signals are to be modulated on the harmonics or else the different frequency bands of the signals 53, 54, 55, the harmonics or else the frequency bands can be separated by means of optical filters, such as the units 47, 48, 49, and each harmonic can also be modulated on the respective signal by means of an electro-optical modulator 50, 51, 52. This can be done using parallel modulation or serial modulation.

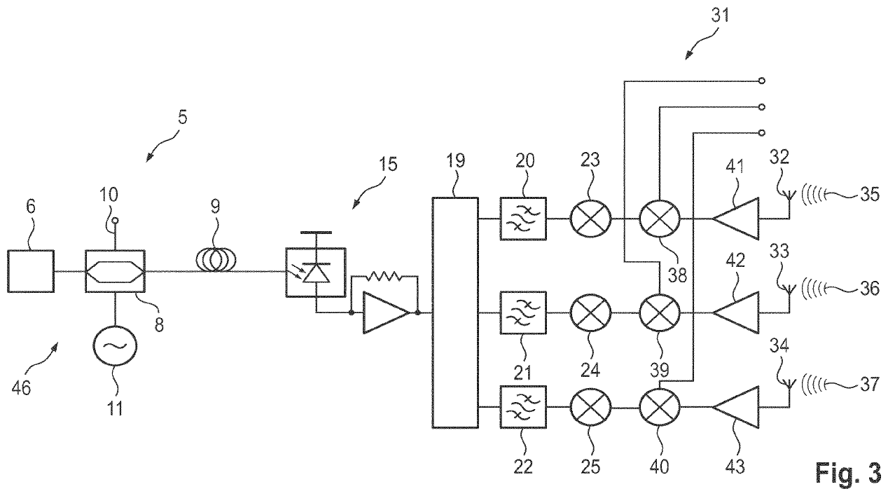

FIG. 3 shows an embodiment of a receiving apparatus 31 of the software-defined radio system 2. For example, the receiving apparatus 31 can be in combination with the transmission apparatus 4. These can be at least partially integrated into an apparatus. For example, the transmission apparatus 4 and the receiving apparatus 31 can be combined in one combination using interchangeable or else actuatable components, so that it is possible to switch between a receiving mode and a transmitting mode, for example, as required.

The receiving apparatus 31 can have at least one radio-based receiving unit 32, 33, 34. These can be radar-based receiving units. With the aid of the radio-based receiving units 32, 33, 34, at least one electrical reception signal 35, 36, 37 can be received. The reception signal or else reception signals 35, 36, 37 can be signals corresponding to the electrical emission signals 16, 17, 18 and reflected in the environment 3.

In particular, the transmission apparatus 4 and the receiving apparatus 31 can be complementary to each other.

For example, the received electrical reception signals 35, 36, 37 can be downconverted by means of at least one mixer 38, 39, 40. In the process, in particular, the respective frequency bands of the reception signals 35, 36, 37 are changed or else adjusted. In addition, depending on the signal strength of the received reception signals 35, 36, 37, amplification can take place by means of respective amplifiers 41, 42, 43. The electrical reception signals 35, 36, 37 can then be provided at electrical outputs. Here, these can be transmitted to the computing apparatus 5 or another evaluation or else processing unit.

In particular, the computing apparatus 5, the transmission apparatus 4 and the receiving apparatus 31 can be physically and/or spatially separate units. Alternatively, the transmission apparatus 4, the receiving apparatus 31, and the computing apparatus 5 can be formed together as a common unit.

### LIST OF REFERENCE NUMERALS

1 Motor vehicle
2 Software-defined radio system
3 Environment
4 Transmission apparatus
5 Computing apparatus
6 Optical apparatus
7 Optical carrier signal
8 Electro-optical modulator
9 Multiple optical emission signals
10 Operating point
11 CW signal
12, 13, 14 Radio-based transmission unit
15 Optical-electronic converter unit
16, 17, 18 Multiple electrical emission signals
19 Distributor
20, 21, 22 Frequency bands
23, 24, 25 Frequency manipulator
26, 27, 28 Amplifier
29 Optical transmission unit
30 Optical unit
31 Receiving apparatus
32, 33, 34 Radio-based receiving unit
35, 36, 37 Electrical reception signals
38, 39, 40 Mixer
41, 42, 43 Amplifier
44, 45 Unit
46 Electro-optical modulator apparatus
47, 48, 49 Optical filters
50, 51, 52 Optical modulators
53, 54, 55 Optical output signals

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A software-defined radio system for detecting surroundings, comprilsing:
an optical apparatus for generating an optical carrier signal;
a transmission apparatus, which is configured to emit electrical emission signals which are based on the optical carrier signal;
an electro-optical modulator, which has a predetermined operating point; wherein the electro-optical modulator is configured to generate multiple optical output signals on the basis of a predetermined operating point and the optical carrier signal in such a way that the multiple optical output signals have different frequency bands from one another;
an electro-optical modulator apparatus, which is configured to generate multiple optical emission signals on the basis of the multiple optical output signals by modulating the multiple optical output signals with at least one electrical CW signal; wherein the transmission apparatus is configured to convert the multiple optical emission signals into multiple electrical emission signals and to emit the multiple electrical emission signals with at least one radio-based transmission unit.

12. The software-defined radio system of claim 11, wherein the electro-optical modulator apparatus is configured to modulate each of the multiple optical output signals with the at least one electrical CW signal.

13. The software-defined radio system of claim 11, wherein the electro-optical modulator apparatus has multiple electro-optical modulators, wherein the multiple electro-optical modulators are configured to modulate each of the multiple optical output signals with a different electrical CW signal.

14. The software-defined radio system of claim 13, wherein the multiple electro-optical modulators of the electro-optical modulator apparatus are connected in series or parallel to each other.

15. The software-defined radio system of claim 11, wherein
the transmission apparatus has at least one optical-electronic converter unit, with which the multiple optical emission signals can be converted into the multiple electrical emission signals; and/or
the transmission apparatus has at least one frequency manipulator, with which at least one frequency band of one of the multiple electrical emission signals can be changed; and/or
the transmission apparatus has at least one electrical amplifier for amplifying at least one frequency band of one of the multiple electrical emission signals.

16. The software-defined radio system of claim 11, comprising
a receiving apparatus, which has at least one radio-based receiving unit for receiving at least one electrical reception signal, in particular the receiving apparatus has at least one mixer, with which a frequency band of the at least one electrical reception signal can be changed; and
a computer, which is configured to process the electrical reception signal.

17. The software-defined radio system of claim 16, wherein the computer has the electro-optical modulator and/or the electro-optical modulator apparatus.

18. A method for operating the software-defined radio system of claim 11, wherein
the electro-optical modulator is operated in a specific operating mode, wherein in the specific operating mode of the electro-optical modulator, the multiple optical output signals are generated in such a way that the multiple optical output signals have different frequency bands from each other, and
the multiple optical output signals are modulated with the at least one electrical CW signal by the electro-optical modulator apparatus so that the multiple optical emission signals are generated.

19. The method of claim 18, wherein the electro-optical modulator is operated in the specific operating mode in such a way that the Nyquist point is defined as the operating point of the electro-optical modulator.

20. A motor vehicle having a software-defined radio system, the software-defined radio system comprising:
an optical apparatus for generating an optical carrier signal;
a transmission apparatus, which is configured to emit electrical emission signals which are based on the optical carrier signal;
an electro-optical modulator, which has a predetermined operating point; wherein the electro-optical modulator is configured to generate multiple optical output signals on the basis of a predetermined operating point and the optical carrier signal in such a way that the multiple optical output signals have different frequency bands from one another;
an electro-optical modulator apparatus, which is configured to generate multiple optical emission signals on the basis of the multiple optical output signals by modulating the multiple optical output signals with at least one electrical CW signal; wherein the transmission apparatus is configured to convert the multiple optical emission signals into multiple electrical emission signals and to emit the multiple electrical emission signals with at least one radio-based transmission unit.

21. The vehicle of claim 20, wherein the electro-optical modulator apparatus is configured to modulate each of the multiple optical output signals with the at least one electrical CW signal.

22. The vehicle of claim 20, wherein the electro-optical modulator apparatus has multiple electro-optical modulators, wherein the multiple electro-optical modulators are configured to modulate each of the multiple optical output signals with a different electrical CW signal.

23. The vehicle of claim 20, wherein the multiple electro-optical modulators of the electro-optical modulator apparatus are connected in series or parallel to each other.

24. The vehicle of claim 20, wherein
the transmission apparatus has at least one optical-electronic converter unit, with which the multiple optical emission signals can be converted into the multiple electrical emission signals; and/or
the transmission apparatus has at least one frequency manipulator, with which at least one frequency band of one of the multiple electrical emission signals can be changed; and/or
the transmission apparatus has at least one electrical amplifier for amplifying at least one frequency band of one of the multiple electrical emission signals.

25. The vehicle of claim 20, comprising a receiving apparatus, which has at least one radio-based receiving unit for receiving at least one electrical reception signal, in particular the receiving apparatus has at least one mixer, with which a frequency band of the at least one electrical reception signal can be changed; and
a computer, which is configured to process the electrical reception signal.

26. The vehicle of claim 25, wherein the computer has the electro-optical modulator and/or the electro-optical modulator apparatus.
